(19) United States
(12) Patent Application Publication
(10) Pub. No.: US 2004/0186635 A1
(43) Pub. Date: Sep. 23, 2004

(54) METHODS AND APPARATUS FOR CORRECTLY ADJUSTING BAROMETRIC PRESSURE SETTINGS ON BAROMETRIC ALTIMETERS

(76) Inventor: Mark T. Manfred, Edina, MN (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/393,823

(22) Filed: Mar. 21, 2003

(51) Int. Cl. G06F 17/00

(52) U.S. Cl. 701/4; 340/970; 340/977

(57) ABSTRACT

A method for detecting an inaccurate barometric pressure adjustment setting on a barometric altimeter is described. The method includes receiving a barometric corrected altitude from the altimeter, receiving an altitude from a global positioning satellite (GPS) system, comparing the barometric corrected altitude with the altitude received from the GPS system, actuating an alarm if the altitudes differ by an amount larger than a threshold value, the threshold value being dependent upon one or more of the received altitudes.

### BACKGROUND OF THE INVENTION

This invention relates generally to flight safety devices and methods, and more specifically to methods and apparatus for producing barometric altimeter settings.

A barometric altimeter is a device for providing altitude information as a function of the value of barometric pressure, based on the direct relationship between pressure and altitude. Most known altimeters utilize a static port to sense the ambient atmospheric pressure near the airplane. One known barometric altimeter port incorporates a vacuum chamber having a movable portion which displaces in proportion to static air pressure. Another known barometric altimeter incorporates an electrical pressure transducer, and has a processor that is interconnected with the transducer through an analog-to-digital converter (ADC). The processor determines an altitude based on the values received from the ADC. In some applications the processor and ADC combination is referred to as an air data module.

However and as described above, barometric altimeters do not directly measure altitude. Barometric altimeters measure pressure and then mathematically convert pressure measurements to altitude values. Barometric altitude, also known as pressure altitude, is therefore determined as a function of pressure based on a standard atmospheric model. However, actual atmospheric conditions can vary widely from the standard atmospheric model, for example, due to normal daily fluctuations in atmospheric pressure. The variation may cause errors in an indicated altitude from a barometric altimeter. Most known barometric altimeters attempt to compensate for the errors caused by deviations from the standard atmospheric model through a manual adjustment made to the barometric altimeter.

Aircraft flying below a certain altitude, for example, 18,000 feet, typically have an adjustment made to the barometric altimeter to account for fluctuations in local barometric pressure which differ from the standard atmospheric model. In one example, the adjustment is performed by adjusting a manual control, for example, a knob that can be set to demarcated settings, which is located within reach of a pilot or other flight crew member. Since such an adjustment is usually a manual procedure, the adjustment is susceptible to human error. As one can easily imagine, any error in a setting for barometric pressure adjustment can cause an error in an altimeter reading. A pilot may depend upon altimeter readings for navigation of the aircraft, and therefore it is imperative that such readings be accurate. Of course, dependency on an inaccurate or erroneous reading for navigation of an aircraft is dangerous.

### BRIEF SUMMARY OF THE INVENTION

In one aspect, a method for detecting an inaccurate barometric pressure adjustment setting on a barometric altimeter is provided. The provided method comprises receiving a corrected barometric altitude from the altimeter, receiving an altitude from a global positioning satellite (GPS) system, and comparing the barometric corrected altitude with the altitude received from the GPS system. Once the comparison takes place, the method continues by actuating an alarm if the altitudes differ by an amount larger than a threshold value, the threshold value being dependent the received altitudes.

In another aspect, an apparatus for detecting inaccurate barometric pressure adjustment settings on a barometric altimeter based on an altitude measured by a GPS system is provided. The apparatus comprises a barometric altimeter configured to communicate a measured altitude, where the altimeter comprises a module configured to allow a manual adjustment of a barometric pressure setting. The apparatus also comprises an alarm mechanism and a flight management system configured to receive the measured altitude from the GPS system and the barometric altimeter. The apparatus is configured to determine a difference in the altitude received from the GPS system and from the barometric altimeter. The apparatus is also configured to enable the alarm mechanism if the difference is greater than a threshold value, the threshold value being dependent upon altitudes received at the flight management system.

In still another aspect, a computer program product used to detect inaccurate barometric pressure adjustment settings on a barometric altimeter is provided. The computer program product comprises a first computer code configured to receive altitude data from a GPS system and a second computer code configured to receive altitude data from a barometric altimeter. The program product further comprises a third computer code configured to compare the received altitude data and determine if a difference between the two received altitudes is greater than a threshold value and a fourth computer code configured to cause an alarm to be actuated if the difference is greater than the threshold.

### BRIEF DESCRIPTION OF THE DRAWINGS

FIG. 1 is a flowchart illustrating a method for ensuring correct barometric pressure adjustment settings on barometric altimeters.

FIG. 2 is an illustration of an aircraft showing an equipment configuration for performing the method illustrated in FIG. 1.

FIG. 3 is a diagram illustrating a barometric pressure adjust alarm system.

### DETAILED DESCRIPTION OF THE INVENTION

Herein described are systems and methods for determining incorrect pressure adjustment settings on barometric altimeters. Another independent source of altitude data, for example, a GPS altitude, is compared to altitude as determined by a barometric altimeter. If the difference in altitude measurements is greater than a threshold, an alarm is activated, causing at least one of a manual or automatic adjustment to the pressure adjustment setting of the barometric altimeter. While described herein with respect to GPS altitude, it is understood that other independent sources of altitude, or data which can be converted into an altitude, are considered to within the scope of the invention.

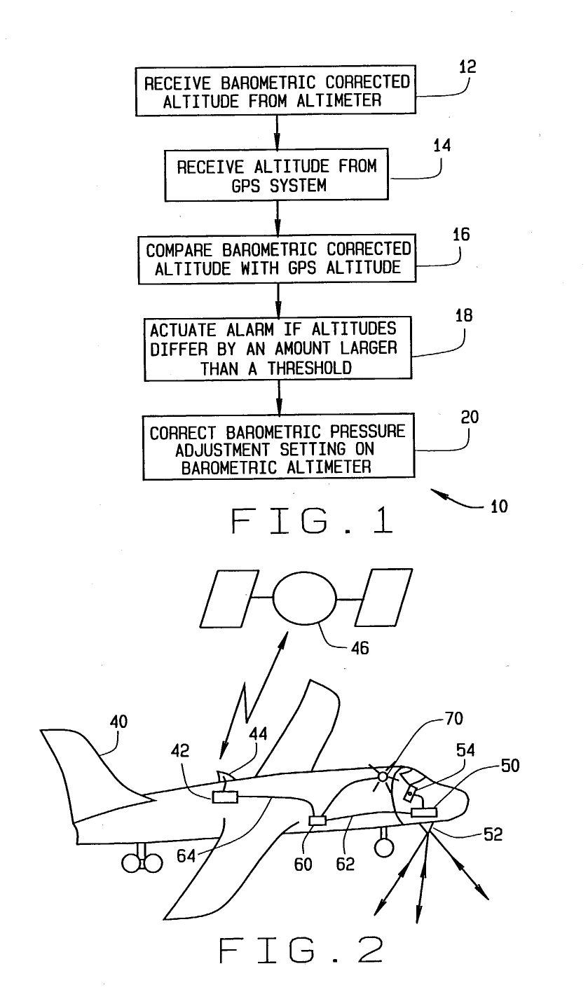

As described above, aircraft pilots flying below certain altitudes typically have to adjust their barometric altimeters to account for local barometric pressure fluctuations, a process which is typically done manually and is therefore susceptible to human error. FIG. 1 is a flowchart 10 illustrating a method for detecting and correcting an inaccurate barometric pressure adjustment setting on a barometric altimeter utilizing an altitude reading from a GPS. While described herein as utilizing GPS to correct and detect an inaccurate barometric pressure adjustment setting on a barometric altimeter, it should be understood that the methods and systems are applicable to other independent sources of altitude other than GPS, for example, radar altimeters.

The method includes the use of GPS to detect if the barometric pressure adjustment, sometimes referred to as baroset adjust, is set to an inaccurate value when the airplane is below a particular altitude threshold. A barometric corrected altitude based on measured pressure is received 12 from a barometric altimeter. An altitude is also received 14 from a GPS system. The inaccuracy of the barometric pressure adjustment setting is determined by comparing 16 the barometric corrected altitude received 12 from the altimeter with the altitude as determined and received 14 from the GPS system. If the two received altitudes differ by more than a threshold value, an alarm is actuated 18 to notify the pilot of this condition. This notification is meant to cause the pilot to recognize the inaccurate barometric pressure adjustment setting. The notification causes the pilot to correct 20 the inaccurate barometric pressure adjustment setting, thereby minimizing a difference between the two above described sources of altitude information.

GPS, as used herein, is contemplated to include any type of global navigation satellite system or GNSS, including but not limited to, space based augmentation systems (SBAS) and ground based augmentation systems (GBAS). An example of a SBAS is a wide area augmentation system (WAAS), which provides a three-sigma altitude accuracy of about 40 feet. An example of a GBAS is local area augmentation system (LAAS), which is believed to provide a three-sigma altitude accuracy of about five feet.

In other embodiments, the barometric pressure adjustment setting is automatically corrected, as it is incorporated as part of a control system (not shown) which compares the two received altitudes. In alternative embodiments, instead of GPS altitude, pseudo-range data (distance from GPS receiver to GPS satellites) or raw (position) data is received from multiple GPS satellites, and a GPS altitude is calculated based upon the distances to the GPS satellites. In another alternative embodiment, a measured atmospheric pressure from the altimeter is received and the barometric pressure adjustment setting is used to adjust this pressure to reflect the static pressure at that altitude. The static pressure is based on the standard atmospheric model, and position data from the GPS is received and utilized to determine an atmospheric pressure based on the standard atmospheric model. The pressures are compared, and a pressure difference threshold, which correlates to an altitude difference threshold, is utilized to determine if the barometric pressure adjustment setting is set inaccurately.

In one known scenario, pilots typically have to manually adjust barometric pressure settings when an aircraft is flying below about 18,000 feet. The altitudes received from both the barometric altimeter and the GPS system are nearly equal when the baroset adjustment is set correctly, but diverge if the baroset adjust is set incorrectly. In one embodiment, the alarm is activated if the two altitudes differ by an amount larger than a threshold value while the aircraft is below 18,000 feet.

In one specific embodiment, the threshold value is set to an approximate root sum square (RSS) of a three-sigma GPS altitude error and a baro-corrected altimeter error, for example, relative to an altitude of a runway. The three-sigma GPS altitude error and the baro-corrected altimeter error change during the course of a flight. Therefore, in alternative embodiments, the threshold value is adjusted based on one or more of an altitude of the aircraft above the runway at which the airplane will land, a distance to the runway, barometric altitude, and a vertical integrity limit as transmitted by a GPS receiver.

Altitude above the runway is important because this is where a baro-corrected altimeter error poses the greatest safety risk as a pilot nears the runway during poor visibility. The pilot utilizes the altimeter to determine when he reaches a “decision height”, and further determines if he has adequate visibility to complete the landing. If the baroset adjustment is set too high, the altimeter would mislead the pilot by showing an altitude that is higher than the actual altitude. Typically, the decision height is at an altitude of about 200 feet above the runway and half a mile from the runway. The threshold value between GPS altitude and barometric altimeter altitude is set tightest at this time because an error in altitude indicated by baro-corrected pressure diminishes as the aircraft's altitude and position approaches the runway. The baro-corrected altimeter error is dominated by a pressure gradient error. For example, at 200 feet above the runway, the three-sigma baro-corrected altimeter error is approximately 70 feet. However, at 18,000 feet the three-sigma baro-corrected altimeter error can be well over 1000 feet.

In certain applications, pressure gradient error has the greatest effect on the magnitude of the threshold value, but the effect can be reduced by compensating the altitude indicated by baro-corrected pressure for temperature, since many modem aircraft have instruments that measure and transmit static air temperature (SAT). In one embodiment, static air temperature is utilized to temperature compensate the baro corrected altitude signal that is compared to the altitude from GPS. Through the temperature compensation, a magnitude of threshold value is significantly reduced.

Aircraft equipped with a flight management system (FMS) are able to determine the altitude above the landing runway by subtracting the runway altitude (from a FMS database) from the altimeter's altitude as indicated by baro-corrected pressure.

Distance to the runway is another possible factor in setting the threshold value. The altitude indicated by baro-corrected pressure becomes more accurate as the aircraft gets closer to the airport, however this is not as strong an effect as the altitude above the airport. Aircraft equipped with a FMS are able to determine the distance to the runway from the FMS. In addition, barometric altitude can be utilized to adjust the threshold value, as well as a vertical integrity limit as transmitted from the GPS receiver, which is an indication of accuracy for the GPS altitude signal.

An example determination of a threshold value includes setting the magnitude of the threshold value to the root sum square of GPS altitude error, pressure gradient error, and horizontal distance error. For purposes of illustrating the example, a GPS altitude error of 0.5 multiplied by a vertical integrity limit, in feet, from the GPS receiver, a pressure gradient error of 0.3 multiplied by an altitude difference between the altimeter and the runway in feet, and a horizontal distance error of 1.5 multiplied by a horizontal distance to the runway in nautical miles (nm) are assumed. To apply numbers to the example, an aircraft that is 300 feet above and 0.75 nm from the runway, using a WAAS receiver that is transmitting a vertical integrity limit of 80 feet is utilized. A pilot alert is activated under this condition if the difference between the altitude indicated by baro-corrected pressure and the GPS altitude (i.e. the threshold value) exceeded +/−98.5 feet.

FIG. 2 is an illustration of an aircraft 40 which includes an apparatus that incorporates the methods for detecting and correcting an inaccurate barometric pressure adjustment setting. Aircraft 40 includes a GPS system 42 and its associated antenna 44 which communicate with satellite 46 in order to determine an altitude of aircraft 40. Aircraft 40 further includes a barometric altimeter 50 with an associated pressure transducer 52 and a module 54 which allows a pilot (not shown) to perform manual barometric pressure adjustments, based upon an altitude as determined by altimeter 50 and based on barometric pressure adjustment information the pilot receives from the airport. The altitude from barometric altimeter 50 may have a large noise component. Therefore, in one embodiment, the barometric altitude signal is low-pass filtered (not shown) before it is compared to altitude from GPS system 42. Low pass filtering provides a mechanism to prevent increasing of the threshold value, due to false alerts caused by noise peaks in the barometric altitude signal.

In an alternative embodiment, it is preferred to low-pass filter a difference signal between baro corrected altitude and GPS altitude, before checking against the threshold value, which allows the threshold value to be reduced while still preventing false alerts. In yet another alternative embodiment, the low-pass filter is configured with a cutoff frequency that is dependent on altitude, for example, the cutoff frequency decreases with increasing altitude.

In the embodiment shown, altimeter 50 and GPS system 42 are communicatively coupled to a central flight management system 60. Flight management system 60 is understood to include any type of processor based system which can receive data regarding altimeter data and GPS data. Altimeter 50 and flight management system 60 are communicatively coupled via data bus 62, wherein at least a barometric corrected altitude is communicated from altimeter 50 to flight management system 60 on data bus 62. Further, GPS 42 and flight management system 60 are communicatively coupled on data bus 64, thereby allowing GPS system 42 to transmit a GPS altitude on data bus 64 to flight management system 60.

In an alternative embodiment, communications between flight management system 60 and altimeter 50 and GPS system 42 are implemented using a single data bus. In another alternative embodiment, flight management system 60 is programmed to automatically correct for an inaccurate barometric pressure adjustment setting, and an alarm to the flight crew is a notification that an adjustment has occurred. It is contemplated that in certain embodiments, the flight crew will be able to override such an automatic adjustment of the barometric pressure adjustment setting. It is also contemplated that inaccurate barometric pressure adjustment settings be determined utilizing measured and determined pressure differentials, as previously described, to determine altitude differentials as between a GPS and a barometric altimeter. As used herein, the term data bus should be construed to include all embodiments and protocols utilized for communicating data between devices.

Flight management system 60 receives altitude information from GPS system 42 and altimeter 50 as described above and is configured to determine a difference in the received altitudes. Flight management system 60 is further configured with a threshold value, which is at least partially dependent on the actual altitudes, as measured, and on an accuracy of the GPS data received. Should the difference in altitudes be above the altitude dependent threshold, flight management system 60 is programmed to activate a detection and alarm system 70 which is at least one of audible or visual. The alarm is therefore communicated to a pilot(s) within aircraft 40. Upon receipt of an alarm condition, the pilot(s) will manually correct, utilizing module 54, the barometric pressure adjustment setting for altimeter 50. Such an adjustment should remove the differences between the altitude readings. Such an adjustment is important at low altitudes, for safety of flight reasons, and at high altitudes since altimeters are less accurate at high altitudes.

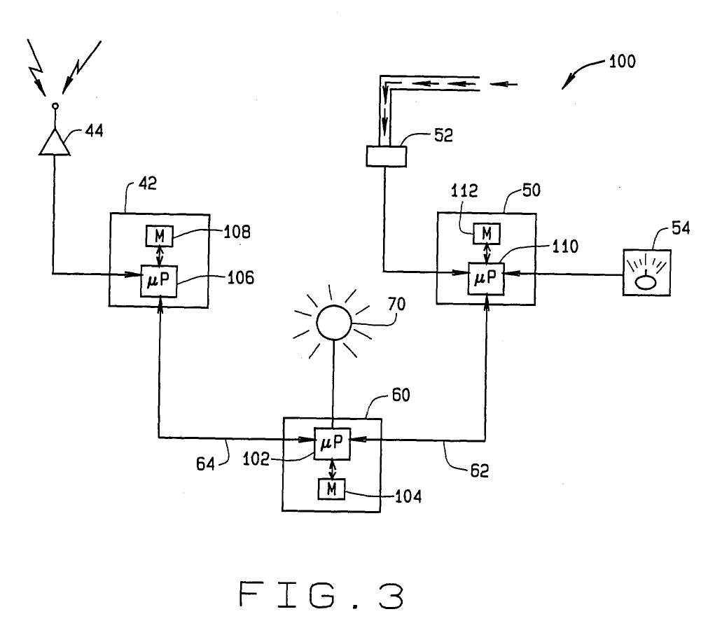

FIG. 3 is a diagram of a barometric pressure adjustment setting alarm system 100 as incorporated into aircraft 40 (shown in FIG. 2). System 100 includes a flight management system 60 which communicates on data busses 62 and 64. Flight management system 60 includes a microprocessor 102 and a memory 104. A flight management program, stored in memory 104 is executed by processor 102 and includes a portion of software which performs comparisons between altitudes received on data busses 62 and 64, and causes microprocessor 102 to energize alarm 70, should a difference in altitudes be above a threshold. Thresholds for various altitude ranges are also stored within memory 104.

GPS system 42 also includes a processor 106 and a memory 108. Processor 106 executes a software program stored in memory 108, thereby controlling operation of GPS 42. Included in the program is code which instructs processor 106 to process data received from GPS satellites (not shown) at GPS antenna 44, including an altitude. Additional code within the program causes microprocessor 106 to send messages (data) out of GPS system 42 and onto data bus 64, the messages including altitude information.

Barometric altimeter 50 also includes a microprocessor 110 and a memory 112. Processor 110 executes a software program stored in memory 112, thereby controlling operation of altimeter 50, based upon inputs received at microprocessor 110 from pressure transducer 52 and module 54. Based upon the inputs from pressure transducer 52 and module 54, and the software program in memory 112, processor 110 prepares messages to be output onto data bus 62. The messages include altitude data as determined based upon instructions within the software program, the pressure sensed by transducer 52, and a setting of module 54. Once flight management system 60 has received messages from both GPS system 42 and barometric altimeter 50, a determination can be made whether alarm 70 should be activated, or an automatic adjustment made to the barometric pressure adjustment setting, as described above.

Once alarm 70 is activated, a setting of module 54 is manually adjusted by a pilot, thereby changing the altitude data that is transmitted onto data bus 62 by altimeter 50. Once the two altitudes received by flight management system 60 are within a threshold of one another, flight management system 60 removes the alarm condition.

It should be emphasized that the system descriptions which incorporate flight management system 60 as the mechanism to determine differences in altitude between GPS 42 and altimeter 50 is an exemplary embodiment only. Many other flight equipment combinations and communications schemes may be implemented to provide the alarming functionally which is described herein. For example, alarm 70 might include a processor and receive communication from flight management system 60 on a data bus. Many other combinations and schemes may also be implemented to automatically adjust the barometric pressure adjustment setting.

Other contemplated methods for detection of inaccurate barometric pressure adjustment setting on a barometric altimeter exist, for example, integration of altitudes from GPS with inertial signals from gyroscopes and accelerometers can be utilized to improve accuracy of GPS altitude readings. Therefore, while the invention has been described in terms of various specific embodiments, those skilled in the art will recognize that the invention can be practiced with modification within the spirit and scope of the claims.

What is claimed is:

1. A method for detecting an inaccurate barometric pressure adjustment setting on a barometric altimeter, said method comprising:
receiving a barometric corrected altitude from the altimeter;
receiving an altitude from a global positioning satellite (GPS) system;
comparing the received barometric corrected altitude with the altitude received from the GPS system; and
actuating an alarm if the altitudes differ by an amount larger than a threshold value, the threshold value being dependent upon the received altitudes.

2. A method according to claim 1 further comprising correcting the barometric pressure adjustment setting on the barometric altimeter.

3. A method according to claim 2 wherein correcting the barometric pressure adjustment setting on the barometric altimeter is one of a manual adjustment or an automatic adjustment made by a flight management system.

4. A method according to claim 1 further comprising correcting the barometric pressure adjustment setting on the barometric altimeter until the alarm is de-actuated.

5. A method according to claim 1 wherein receiving a barometric corrected altitude comprises receiving the barometric altitude on a data bus.

6. A method according to claim 1 wherein receiving an altitude from a GPS system comprises receiving the GPS altitude on a data bus.

7. A method according to claim 1 wherein receiving an altitude from a GPS system comprises:
receiving pseudo-range data at the GPS from one or more GPS satellites; and
determining a GPS altitude based on the pseudo-range data.

8. A method according to claim 1 wherein receiving an altitude from a GPS system comprises:
receiving data at the GPS from one or more GPS satellites;
calculating a position of the aircraft based on the data; and
determining a GPS altitude based on the aircraft position.

9. A method according to claim 1 wherein receiving an altitude from a GPS system comprises receiving an altitude from at least one of a global navigation satellite system, a space based augmentation system, a ground based augmentation system, a wide area augmentation system, and a local area augmentation system.

10. A method according to claim 1 wherein actuating an alarm comprises communicating at least one of an audible or a visual alarm to a pilot.

11. A method according to claim 1 wherein receiving a barometric altitude comprises receiving a measured atmospheric pressure from the altimeter.

12. A method according to claim 11 wherein receiving an altitude from a GPS system further comprises determining an atmospheric pressure for a received GPS position based on a standard atmospheric model.

13. A method according to claim 12 further comprising:
adjusting the measured atmospheric pressure based on the barometric pressure adjustment setting; and
comparing the adjusted, measured atmospheric pressure to the determined atmospheric pressure based on the received GPS position and the standard atmospheric model.

14. A method according to claim 1 wherein comparing the received barometric altitude with the altitude received from the GPS system comprises setting the threshold value to a root sum square of a three sigma GPS altitude error, a baro-corrected altitude error, and an altitude of a runway at which landing is to occur.

15. A method according to claim 1 wherein comparing the received barometric altitude with the altitude received from the GPS system comprises compensating the received barometric altitude for temperature utilizing a static air temperature.

16. A method according to claim 1 wherein the threshold value further depends on one or more of an altitude of the aircraft above a runway at which the airplane will land, a distance to the runway, a barometric altitude, and a vertical integrity limit of the GPS altitude.

17. A method according to claim 1 further comprising filtering the barometric corrected altitude to remove noise from a barometric altitude signal.

18. An apparatus for detecting inaccurate barometric pressure adjustment settings on a barometric altimeter based on an altitude measured by a GPS system, said apparatus comprising:
a barometric altimeter configured to communicate a measured altitude, said altimeter comprising a module configured to allow a manual adjustment of a barometric pressure setting;
an alarm mechanism; and
a flight management system configured to receive the measured altitude from the GPS system and said barometric altimeter, said apparatus configured to determine a difference in the altitude received from the GPS system and said barometric altimeter, said apparatus configured to enable said alarm mechanism if the difference is greater than a threshold value, the threshold value being dependent upon altitudes received at said flight management system.

19. An apparatus according to claim 18 wherein said alarm mechanism comprises at least one of an audible alarm and a visual alarm.

20. An apparatus according to claim 18 wherein said flight management system is configured to supply data to said barometric altimeter which corrects the barometric pressure adjustment setting.

21. An apparatus according to claim 18 wherein said barometric altimeter communicates altitudes to said flight management system using a data bus.

22. An apparatus according to claim 18 wherein said flight management system causes said alarm mechanism to be actuated until the barometric pressure adjustment setting on the barometric altimeter is set to a setting which causes the differences in the altitudes received by said flight management system to be within the threshold value.

23. An apparatus according to claim 18 wherein to communicate a measured altitude, said altimeter transmits a measured atmospheric pressure to said flight management system, said flight management system configured to convert a measured atmospheric pressure to an altitude.

24. An apparatus according to claim 18 wherein to receive an altitude from the GPS system, said flight management system is configured to determine an atmospheric pressure for a received GPS position based on a standard atmospheric model.

25. An apparatus according to claim 18 wherein said flight management system is configured to set the threshold value to a root sum square of a three sigma GPS altitude error, a baro-corrected altitude error, and an altitude of a runway at which landing is to occur.

26. An apparatus according to claim 18 wherein said flight management system is configured to compensate the received barometric altitude utilizing a measurement of static air temperature.

27. An apparatus according to claim 18 wherein the threshold value is further dependent upon one or more of an altitude of the aircraft above a runway at which the airplane will land, a distance to the runway, corrected barometric altitude from said barometric altimeter, and a vertical integrity limit of the GPS system.

28. A computer program product used to detect inaccurate barometric pressure adjustment settings on a barometric altimeter, comprising:
a first computer code configured to receive altitude data from a GPS system;
a second computer code configured to receive altitude data from a barometric altimeter;
a third computer code configured to compare the received altitude data and determine if a difference between the two received altitudes is greater than a threshold value; and
a fourth computer code configured to cause an alarm to be actuated if the difference is greater than the threshold.

29. A computer program product according to claim 28 wherein said third computer code is configured to compare the difference in received altitudes to a threshold value, the threshold value being dependent upon one or more of the received altitudes.
